(19) United States
(12) Patent Application Publication
(10) Pub. No.: US 2026/0172200 A1
(43) Pub. Date: Jun. 18, 2026

(54) WIRELESS COMMUNICATION DEVICE AND METHOD FOR SUPPORTING BLOCK ACKNOWLEDGEMENT MECHANISM

(71) Applicant: TP-Link Systems Inc., IRVINE, CA (US)

(72) Inventors: Shuyu SHI, Shanghai (CN); Qingwei FU, Shenzhen (CN)

(73) Assignee: TP-Link Systems Inc., IRVINE, CA (US)

(21) Appl. No.: 18/979,563

(22) Filed: Dec. 12, 2024

(51) Int. Cl. H04L 5/00; H04L 1/08

(52) U.S. Cl. CPC H04L 5/0055; H04L 1/08

(57) ABSTRACT

The present disclosure provides a wireless communication device, method, system and computer program product for supporting BA mechanism. The wireless communication method includes: receiving, from a peer wireless communication device, a support indication for sparse block acknowledgment (BA) bitmap condensation for a plurality of data frames to be communicated between the wireless communication device and the peer wireless communication device in a BA session; and transmitting, to the peer wireless communication device, a condensed BA bitmap for the BA session based on the support indication.

### TECHNICAL FIELD

The present disclosure relates to wireless communication, and more specifically, to a wireless communication device, method, system and computer program product for supporting block acknowledgement (BA) mechanism.

### BACKGROUND

In the context of Wi-Fi communication, an acknowledgement (ACK) procedure has been proposed to ensure the integrity and reliability of data transmission. Upon successful reception of a data frame from a transmitting device (e.g., an originator device), the receiving device (e.g., a recipient device) sends an ACK frame back to the transmitting device for acknowledging the data frame received.

Block acknowledgement (BA) mechanism was introduced in the 802.11e amendment to improve efficiency by allowing for the transfer of a block of data frames that are acknowledged with a single BA frame instead of an ACK frame for each of the individual data frames. However, there is still a need for enhancements on the BA mechanism.

### SUMMARY

In view of the above problems, the present disclosure provides a wireless communication device, method, system and computer program product for supporting block acknowledgement (BA) mechanism.

According to one embodiment of the present disclosure, there is provided a wireless communication device, comprising: one or more processors; a memory coupled to at least one of the processors; and a set of computer program instructions stored in the memory, which, when executed by at least one of the processors, perform actions of: receiving, from a peer wireless communication device, a support indication for sparse block acknowledgment (BA) bitmap condensation for a plurality of data frames to be communicated between the wireless communication device and the peer wireless communication device in a BA session; and transmitting, to the peer wireless communication device, a condensed BA bitmap for the BA session based on the support indication.

According to another embodiment of the present disclosure, there is provided a method for wireless communication, the method implemented in a wireless communication device and comprising: receiving, from a peer wireless communication device, a support indication for sparse BA bitmap condensation for a plurality of data frames to be communicated between the wireless communication device and the peer wireless communication device in a BA session; and transmitting, to the peer wireless communication device, a condensed BA bitmap for the BA session based on the support indication.

According to yet another embodiment of the present disclosure, there is provided a computer program product for wireless communication, the computer program product comprising a non-transitory computer readable storage medium having program instructions embodied therewith, the program instructions executable by a processor of a wireless communication device to cause the processor to: receive, from a peer wireless communication device, a support indication for sparse BA bitmap condensation for a plurality of data frames to be communicated between the wireless communication device and the peer wireless communication device in a BA session; and transmit, to the peer wireless communication device, a condensed BA bitmap for the BA session based on the support indication.

According to still another embodiment of the present disclosure, there is provided a wireless communication system comprising at least a wireless communication device and a peer wireless communication device. The wireless communication device may be configured to perform actions of: receiving, from a peer wireless communication device, a support indication for sparse BA bitmap condensation for a plurality of data frames to be communicated between the wireless communication device and the peer wireless communication device in a BA session; and transmitting, to the peer wireless communication device, a condensed BA bitmap for the BA session based on the support indication. Accordingly, the peer wireless communication device may be configured to perform actions of: transmitting, to the wireless communication device, the support indication for the sparse BA bitmap condensation for the plurality of data frames to be communicated between the wireless communication device and the peer wireless communication device in the BA session; receiving, from the wireless communication device, the condensed BA bitmap; and retransmitting, to the wireless communication device, the one or more missing data frames of the plurality of data frames.

At least based on the above embodiments of the present disclosure, an enhanced BA mechanism for data transmissions between the wireless communication devices can be realized while reducing the overhead associated with the transmission of BA frames or bitmaps.

### BRIEF DESCRIPTION OF THE DRAWINGS

The above and other aspects, features and advantages of the present disclosure will become more apparent by describing embodiments of the present disclosure in more detail in conjunction with accompanying drawings. The drawings are used to provide a further understanding of the embodiments of the present disclosure and constitute a part of the specification. The drawings together with the embodiments of the present disclosure are used to explain the present disclosure, but do not constitute a limitation on the present disclosure. In the drawings, unless otherwise explicitly indicated, the same reference numerals refer to the same components, steps or elements.

FIG. 1 shows an exemplary network topology for data transmission between wireless communication devices according to an embodiment of the present disclosure.

FIG. 2A shows an exemplary schematic diagram illustrating the message sequence for interactions between wireless communication devices in the Immediate BA mechanism.

FIG. 2B shows an exemplary schematic diagram illustrating fragmentation of a MAC Service Data Unit (MSDU) according to IEEE 802.11 standards.

FIG. 3 shows an exemplary schematic diagram illustrating sparse bitmaps for the block ack frame in the existing BA mechanism.

FIG. 4 shows an exemplary schematic diagram illustrating examples of several BA bitmaps in the existing BA mechanisms.

FIG. 5A shows an exemplary schematic diagram of mapping the identification information of one or more missing data frames of the plurality of data frames to corresponding bits of the condensed BA bitmap according to an embodiment of the present disclosure.

FIG. 5B shows another exemplary schematic diagram of mapping the identification information of one or more missing data frames of the plurality of data frames to corresponding bits of the condensed BA bitmap according to an embodiment of the present disclosure.

FIG. 6 shows an exemplary schematic diagram of determining missing data frames of the plurality of data frames based on corresponding bits of the condensed BA bitmap according to an embodiment of the present disclosure.

FIG. 7 shows an exemplary schematic diagram illustrating an enhanced immediate BA mechanism according to an embodiment of the present disclosure.

FIG. 8 shows an exemplary schematic diagram illustrating an enhanced delayed BA mechanism according to an embodiment of the present disclosure.

FIG. 9 shows another exemplary schematic diagram illustrating an enhanced BA mechanism according to an embodiment of the present disclosure.

FIG. 10 shows an exemplary schematic diagram illustrating a frame structure for the enhanced BA mechanism according to an embodiment of the present disclosure.

FIG. 11 shows an exemplary schematic diagram of condensing the BA bitmap based on a partial virtual bitmap mechanism according to an embodiment of the present disclosure.

FIG. 12 shows an exemplary schematic diagram illustrating another frame structure for the enhanced BA mechanism according to an embodiment of the present disclosure.

FIG. 13 shows a flowchart of a computer-implemented method of wireless communication according to an embodiment of the present disclosure.

FIG. 14 is an exemplary block diagram illustrating a computing device according to embodiments of the disclosure.

### DETAILED DESCRIPTION

The technical solution of the present disclosure will be clearly and completely described below in conjunction with accompanying drawings. Obviously, the described embodiments are part of embodiments of the present disclosure, but not all of them. Based on the embodiments in the present disclosure, all other embodiments obtained by ordinary skilled in the art without making any creative efforts fall within the scope of protection of the present disclosure.

In the description of the present disclosure, it should be noted that orientations or positional relationships indicated by terms such as “center”, “upper”, “lower”, “left”, “right”, “vertical”, “horizontal”, “inside” and “outside” are based on orientations or positional relationships shown in the drawings, only for the convenience of describing the present disclosure and simplifying the description, instead of indicating or implying the indicated device or element must have a particular orientation. In addition, terms such as “first”, “second” and “third” are only for descriptive purposes, and cannot be understood as indicating or implying relative importance. Likewise, words like “a”, “an” or “the” do not represent a quantity limit, but represent an existence of at least one. Words like “include” or “comprise” mean that an element or an object in front of the said word encompasses those ones listed following the said word and their equivalents, without excluding other elements or objects. Words like “connect” or “link” are not limited to physical or mechanical connections, but may include electrical connections, whether direct or indirect.

In the description of the present disclosure, it should be noted that, unless otherwise explicitly specified and limited, terms such as “mount”, “link” and “connect” should be understood in a broad sense. For example, such terms may refer to being fixedly connected, or detachably connected, or integrally connected; may refer to being mechanically connected, or electrically connected; may refer to being directly connected, or indirectly connected via an intermediate medium, or internally connected inside two elements. For ordinary skilled in the art, the meanings of the above terms in the present disclosure may be understood on a case-by-case basis.

In addition, technical features involved in different embodiments of the present disclosure described below may be combined with each other as long as no conflicts occurs therebetween.

In the present disclosure, an AP, which may be interchangeably referred to as a wireless access point (WAP), is a communication device that can communicate with a non-AP (e.g., a station (STA) or client device) in a WLAN and that allows the non-AP to connect to a wired network. The AP usually connects to a router (via a wired network) as a standalone device, but it can also be integrated with or employed in the router. Likewise, in the present disclosure, a non-AP (e.g., a client device or station, which is interchangeably referred to as a STA) is a communication device that can communicate with an AP to obtain various communication services such as voice, video, packet data, messaging, broadcast, etc. The STA may be any device that contains an IEEE 820.11-conformant media access control (MAC) and physical layer (PHY) interface to the wireless medium (WM). For example, a STA may be a laptop, a desktop personal computer (PC), a personal digital assistant (PDA), an access point or a Wi-Fi phone in a WLAN environment. The STA may be fixed or mobile. In the WLAN environment, the terms “STA”, “client device”, “wireless client”, “user” and “user device” are often used interchangeably.

In the present disclosure, a STA in a WLAN may work as an AP at a different occasion, and vice versa. This is because communication devices in the context of IEEE 820.11 (Wi-Fi) technologies may include both STA hardware components and AP hardware components. In this manner, the communication devices may switch between a STA mode and an AP mode, based on actual WLAN conditions and/or requirements. In various embodiments below, a non-AP STA may refer to a STA in a WLAN that is not implemented as an AP.

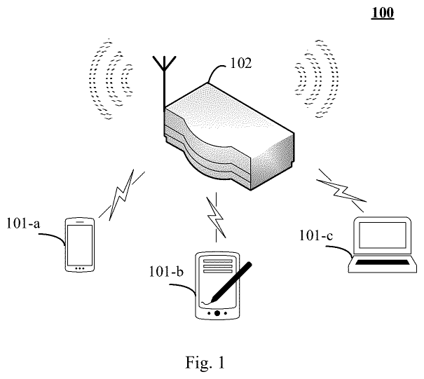

FIG. 1 shows an exemplary network topology for data transmission between wireless communication devices according to an embodiment of the present disclosure.

As shown in FIG. 1, the exemplary network topology 100 is depicted, which includes three client devices 101-a, 101-b, and 101-c (collectively referred to as a client device 101) connected to an access point (AP) 102, and may be employed in 802.11 WLAN networks. Examples of the client devices 101 may include, for example, smartphones, tablets, computers, and other internet-capable devices. As previously discussed, the AP 102 can establish WLAN communication with the client devices 101, enabling the client devices to connect to a wired network. This permits the client devices to access a variety of communication services from the Internet, including voice, video, packet data, messaging, and broadcast, among others. After the client devices 101 successfully associates with the AP 102 through the 802.11 association procedure, data transfer between the client devices 101 and the AP 102 can commence. This allows the client devices 101 to transmit and receive data packets to and from the network through the AP 102.

The architecture presented in FIG. 1 is only illustrative and does not impose any limitations on any embodiment of the present disclosure. Multiple APs in the WLAN network can serve specific sets of associated client devices, and depending on application requirements and overall network constraints, the number of client devices in each serving set may be greater or less than the three client devices as depicted.

As mentioned above, BA mechanism is proposed in 802.11 Standards to facilitate data communications in WLAN networks. Two approaches of BA were originally defined in the 802.11e Amendment: Immediate BA and Delayed BA. Furthermore, both BA approaches are enhanced in the 802.11n Amendment to improve efficiency and take advantage of aggregation and the higher data rates, and the enhanced mechanisms of BA are referred to as high-throughput (HT)-immediate BA and HT-delayed BA. However, the existing BA mechanisms still require further improvements, as described hereinafter.

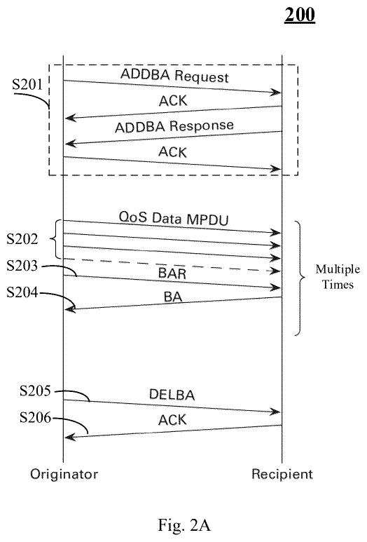

FIG. 2A shows an exemplary schematic diagram illustrating the message sequence for interactions between wireless communication devices in the Immediate BA mechanism.

As shown in FIG. 2A, the wireless communication device with data frames to send is referred to as originator, transmitter, or transmitting device, while another wireless communication device serving as a receiver of the data frames is referred to as recipient, receiver, or receiving device. For example, in conjunction with the topology 100 shown in FIG. 1, when there is a downlink data transmission from the AP 102 to the client device 101, the AP is the originator and the client device is the recipient; conversely, when there is an uplink data transmission from the client device 101 to the AP 102, the client device is the originator and the AP is the recipient. During data communication between the two wireless communication devices, the Immediate BA mechanism may be implemented, which is described hereinafter in combination with the message sequence 200 of FIG. 2A.

At a first stage for BA session initiation (i.e., setup stage), as shown in step S201 of FIG. 2A, the BA mechanism needs to be enabled by establishing a BA session through the exchange of ADDBA Request and Response, as well as their responding ACKs. The BA session is established between two wireless communication devices for a particular traffic identifier (TID) and for data transfer in one direction, i.e., from originator to recipient.

At a second stage for BA session data transfer (i.e., data and acknowledgment transfer stage), as shown in steps S202-S204 of FIG. 2A, the data transfer is started after a successful ADDBA exchange. The originator will send a block of data (e.g., Quality of Service (QOS) Data MPDUs) in step S202 followed by a BAR in step S203, to which the recipient will respond with a BA in step S204. The BA in step S204 acknowledges correctly received data frames from the block of data frames sent in step S202 and disacknowledges incorrectly received data frames from the block of data frames sent in step S202. The originator requeues data frames which were not correctly received and may re-transmit them in the subsequent block or round of data frames (not shown). In addition, the above steps S202-S204 may be performed many times if there is continuous data transmission from the originator to the recipient, which means several rounds or several blocks of data frames may be communicated.

At a third stage for BA session tear down (i.e., tear down stage), as shown in steps S205-S206 of FIG. 2A, the originator or recipient may tear down the BA session by sending a DELBA Request in step S205 which, if correctly received, is acknowledged with an ACK in step S206 as a response.

FIG. 2B shows an exemplary schematic diagram illustrating fragmentation of a MAC Service Data Unit (MSDU) according to IEEE 802.11 standards.

According to IEEE 802.11 standards, fragmentation is used to break up large MSDUs to improve the chance that the MSDU will be received correctly and to reduce the overhead of retransmission. At low data rates, an unfragmented MSDU can occupy a large amount of air time, making it susceptible to changing channel conditions. A bit error in the frame would result in the entire frame being retransmitted. With fragmentation, the MSDU would be broken into smaller segments and each segment encapsulated in an MPDU. Each MPDU is sent in a separate PPDU with the preamble of each PPDU providing a new channel estimate. A bit error would result in only the MPDU carrying the errored segment being retransmitted. The fragments making up an MSDU are sent as individual MPDUs.

As shown in the schematic diagram 200-B of FIG. 2B, the MSDU (with a sequence number of x) may be broken into sixteen segments (or fragments) and each segment encapsulated in an MPDU. The fragments, such as Fragments 0˜15, are delivered in sequence, as labeled by x.0, x.1, . . . , x.15.

In general, one of the main goals of 802.11bn is to support lower latency. However, the bitmap field in a block ack frame is often a sparse array or equivalently a sparse bitmap due to several reasons, which results in a large overhead and a waste of transmission resources, as described hereinafter.

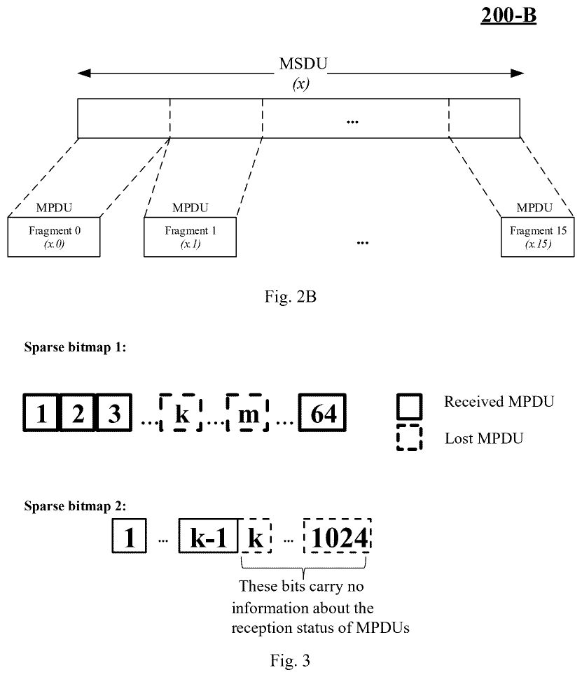

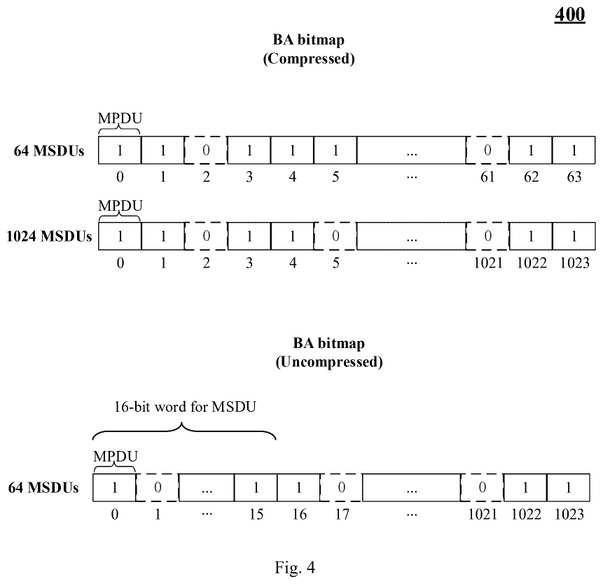

FIG. 3 shows an exemplary schematic diagram illustrating sparse bitmaps for the block ack frame in the existing BA mechanism.

As an example, in the exchange a block of QoS data frames within the BA session, the number of successfully received MPDUs is much larger than that of the lost MPDUs, as the PER is relatively low in most scenarios of Wi-Fi deployment. For example, as shown in the upper half of FIG. 3, which is marked sparse bitmap 1, an exemplary 64-bit array of bitmap in BA frame may be used for indicating the k^{th} MPDU and the m^{th} MPDU lost, which require retransmission, hence there are 62 bits of 1s and 2 bits of 0s, which is a sparse array.

As another example, commonly, during BA session data transfer, the number of required QoS MPDUs is smaller than array size of bitmap (64bits or 1024bits), hence the bit array of bitmap is not fully utilized to indicate the QoS frames are received or not. In addition, preemption is considered to be a mechanism for aperiodic LL traffics in 802.11bn. To this end, it has been discussed that large PPDU should split into small PPDUs. Therefore, a significant small number of MPDUs is contained within the A-MPDU for transmission in every spitted small PPDUs. The inefficient usage of bitmap is significantly severer in preemption scenarios. For example, as shown in the lower half of FIG. 3, which is marked sparse bitmap 2, an exemplary 1024-bit array of bitmap in BA frame is used in case where only k−1 MPDUs are aggregated with an A-MPDU within a PPDU. However, since there are only k−1 MPDUs transmitted during the data transfer, the bits k˜1024 of the bitmap carry no information about the reception status of MPDUs, which is unnecessary overhead for the BA frame.

In this case, inventors recognize that the sparsity of bitmap field of the existing BA frame has the potential to condense to reduce the air-time consumption of block ack bitmap field and the overhead, eventually leading to improved latency performance. For example, as long as the two communication devices have the capability for sparse BA bitmap condensation, e.g., by signaling a support indication thereof, the two communication devices can proceed with the processing (such as generating, transmitting, receiving, parsing, among other examples) of the condensed BA bitmap instead of a tradition BA bitmap. In such cases, compared with the traditional BA bitmap whose size should be equal to the maximum number of data frames that may be communicated for each round of BA session (e.g., the buffer size for frames at the recipient negotiated during the BA setup stage, such as the size of 64 in the above sparse bitmap 1 or the size of 1024 in the above sparse bitmap 2 of FIG. 3), the present disclosure provides the condensed BA bitmap whose size may be far less than the maximum number of data frames that may be communicated for each round of BA session, which does not rely on a one-to-one mapping relationship between one data frame and one bit of the BA bitmap and thus efficiently compresses the BA bitmap overhead. In view of this, the present disclose has provided several ways to condense the sparse bitmap of BA frame.

FIG. 4 shows an exemplary schematic diagram illustrating examples of several BA bitmaps in the existing BA mechanisms.

In the current BA mechanism, the BA frame may be used to provide the feedback on whether each of the corresponding data frames, namely, the corresponding MAC Protocol Data Units (MPDUs), have been successfully received through its BA bitmap.

As illustrated in the schematic diagram 400 of FIG. 4, the current BA bitmap may be divided into two categories: one for uncompressed BA bitmap and the other for compressed BA bitmap. As mentioned below, although the compressed BA bitmap mechanism may reduce the size of the BA bitmap to some extent, the bitmap in the BA frame still occupies a significant amount of transmission resources.

In the upper half of FIG. 4, for the compressed BA, the bitmap can support feedback for either 64 or 1024 MSDUs. Each bit in the bitmap corresponds to whether the corresponding MPDU (i.e., the unfragmented MSDU, meaning a one-to-one correspondence between the MPDU and the MSDU) has been successfully received. For instance, a value of ‘1’ for a bit in the bitmap indicates that the MPDU corresponding to that bit has been correctly received, while a value of ‘0’ for a bit in the bitmap indicates that the MPDU corresponding to that bit has not been received. In the example of FIG. 4, MSDU #2, and #61 for the case of a total of 64 MSDUs and MSDU #2, #5, . . . , #1021 for the case of a total of 1024 MSDUs have not been successfully received. Consequently, 8 octets (i.e., 64 bits) for the case of a total of 64 MSDUs and 128 octets (i.e., 1024 bits) for the case of a total of 1024 MSDUs are required, respectively, for the transmission of the BA bitmap in the two scenarios.

In the lower half of FIG. 4, for the uncompressed BA, the bitmap can support feedback for a total of 64 MSDUs, where each bit in the bitmap indicates whether the corresponding MPDU (i.e., a corresponding fragment of the fragmented MSDU, meaning the MPDU corresponds to a fragment of the MSDU) has been successfully received. For example, if each MSDU supports up to 16 fragments, then a 16-bit word in the BA bitmap represents the reception status of each fragment of each MSDU, where ‘1’ indicates that the corresponding fragment has been correctly received, and ‘0’ indicates that it has not been received. Therefore, in this scenario, 128 octets (i.e., 1024 bits) are required for the transmission of the BA bitmap.

However, as mentioned above in connection with FIG. 3 for the inventors have recognized that during the reception of Wi-Fi packets, the packet loss rate is typically very low, with the number of received packets far exceeding the number of lost packets. Consequently, the number of ‘1’s in the BA bitmap is much greater than the number of ‘0’s (i.e., the BA bitmap to be transmitted belongs to a sparse matrix or sparse data). In practice, theoretically, only the information about lost packets needs to be fed back to allow for the retransmission of the lost packets. Therefore, the current design of the BA bitmap mechanism results in a waste of data bits, thereby reducing transmission efficiency.

Moreover, in the discussions for the new 802.11bn specifications, to support low latency, the next-generation standard may mandate the size of the PPDU, prohibiting the occurrence of a large payload in the PPDU. As a result, the number of MSDUs will further increase, and consequently, the current redundant BA bitmap design will lead to more BA bitmap overhead and waste of transmission resources in the new protocol, having a more severe impact on transmission performance. In other words, due to the low packet loss rate, the BA bitmap is generally a sparse matrix, and the BA frame is usually transmitted at a low rate (<20 Mbps), resulting in a large overhead for the bitmap in the BA frame and a waste of transmission resources, and further compression is needed for the redundant BA bitmap.

Considering the afore-mentioned issues, to address the large overhead of the bitmap field in the BA frame in the current BA mechanism, the present disclosure proposes a scheme for compressing the sparse BA bitmap, thereby providing an approach for compressing the BA bitmap overhead. Compared to the existing BA feedback mechanism, which requires a long BA bitmap for each of the multiple data frames to indicate whether they have been successfully received (as described above, 8 octets or 128 octets), the present disclosure reduces the length of the BA bitmap by mapping the identification information of only the unreceived data frames to a condensed BA bitmap with reduced bit positions compared with existing BA mechanisms, thereby reducing the overhead of air transmission and simplifying the BA frame.

It should be noted that the condensed BA bitmap of the present disclosure is totally different from the existing uncompressed BA bitmap and compressed BA bitmap, which highly relies on a one-to-one mapping relationship between a data frame and a bit of the BA bitmap. For example, the present disclosure proposes algorithmic mapping of only the missing data frames to corresponding bits of a condensed BA bitmap with a second number of bits (which is less than a first number of the plurality of data frames to be communicated in each round of the BA session), instead of a one-to-one mapping between the plurality of data frames and a plurality of corresponding bits of the conventional BA bitmap (e.g., uncompressed BA bitmap and compressed BA bitmap) with the first number of bits, which is the same as the number of the plurality of data frames.

For example, inventors noted that as one of compression approaches, bloom filters have been applied in many fields related to sparse data processing, such as database queries. According to embodiments of the present disclosure, the bloom filter is used as an example for compressing the sparse BA bitmap into a condensed BA bitmap. In generally, the present disclosure proposes solutions to condense sparse bitmap in BA frame into smaller size, for example, by using a bloom filter bit array subfield for BA frame to replace the current bitmap subfield of the BA frame, thereby reducing the size of current bitmap if the sparsity of current bitmap is satisfied, which is described as follows.

It should be noted that while the present disclosure primarily uses the bloom filter as an example to illustrate the process of mapping the identification information of lost frames to a bitmap with reduced bit positions, it is also possible to employ other methods to map the identification information of lost frames to reduce the BA overhead. For instance, it is also possible that only the identification information of the lost frames (such as the Sequence Number) is filled into the bitmap, with separators or dividers inserted between the identification information of the lost frames, if needed. This approach can reduce the overhead of BA feedback by mapping only the identification information of the lost frames, especially when the number of lost frames is small. Additionally, compressive sensing (CS) techniques may be applied to compress the sparse BA bitmap, thereby reducing the number of bits required for feedback. Those skilled in the art understand that other compression methods suitable for sparse matrix can also be used to map the identification information of lost frames into a bitmap with reduced bit positions, which is not limited in the present disclosure.

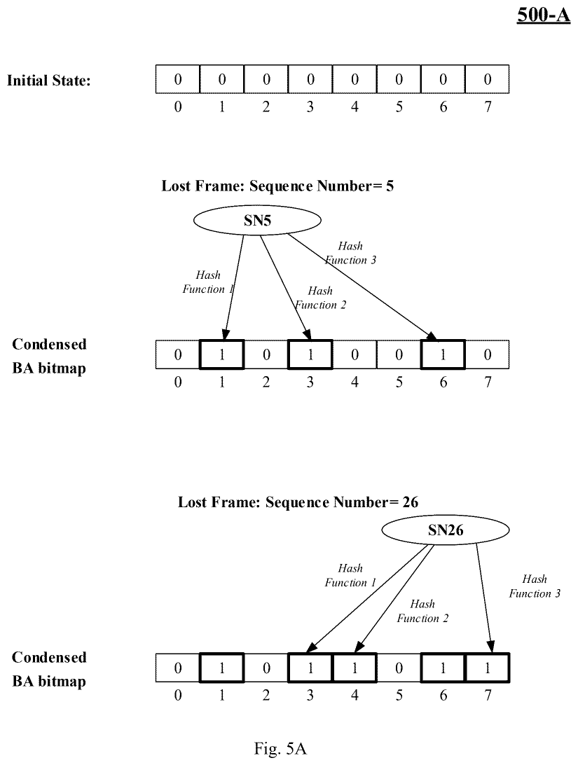

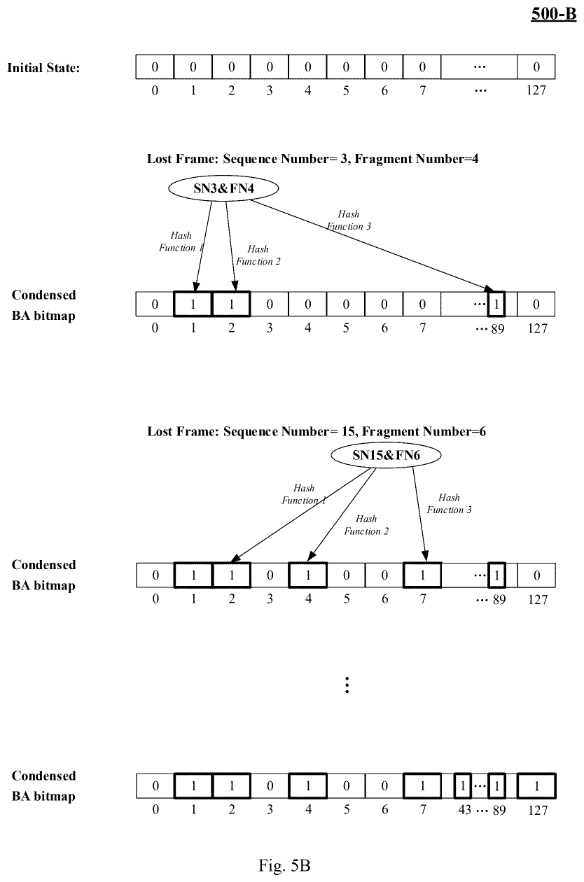

FIG. 5A shows an exemplary schematic diagram of mapping the identification information of one or more missing data frames of the plurality of data frames to corresponding bits of the condensed BA bitmap according to an embodiment of the present disclosure.

FIG. 5A illustrates an example of using a bloom filter to map the identification information of lost data frames (e.g., MPDUs) to a condensed BA bitmap with a reduced number of bits, in case of unfragmented MSDUs where each MPDU corresponds to one MSDU.

A bloom filter, conceived by Burton Howard Bloom in 1970, is a space-efficient probabilistic data structure used to test whether an element is a member of a set. It is widely applied in scenarios such as deduplication of web page URLs, spam email identification, detection of duplicate elements in sets, and query acceleration in key-value storage systems. The bloom filter includes a binary vector or bitmap of a fixed size (corresponding to a length of m) and a set of hash functions (corresponding to a number of k). As shown in the schematic diagram 500-A of FIG. 5A, in the initial state, for a bit array of length m (in this example, length of 8), all bits are set to 0.

The process of adding elements or entries representing lost data frames to the bloom filter (i.e., mapping the identification information of lost data frames to the bitmap) is as follows. Utilizing the bloom filtering mechanism, the identification information of data frames that have not been successfully transmitted is mapped through k hash functions to k bits of a bit sequence (or equivalently, bit array, or bitmap) of length m, where the mapped bit positions are set to 1, and the unmapped bit positions remain 0. If during a BA process, the receiver finds that n data frames have not been successfully received, then the identification information of each of the n data frames is mapped successively using the same set of hash functions, updating the mapped bit positions of the bitmap for each time of the mapping. The bitmap obtained after mapping all the lost data frames to the corresponding bits of the bitmap through the hash functions is the final bitmap to be fed back to the transmitter to allow for the retransmission, which recovers the identification information of the lost data frames by using the same mapping process based on the same set of hash functions, as described hereinafter. It should be noted that the condensed bitmap obtained using the bloom filter is also referred to as condensed bit array, bloom filter bit array, or bloom filter bit array field throughout the present disclosure.

As described, when adding an element to the bloom filter, k hash functions are used to calculate on the input value (i.e., identification information (ID) of the lost data frame, such as the 12-bit Sequence Number of the lost data frame, which is indicated in Sequence Control filed of a MAC frame format), yielding khash values (optionally, modulo operations may be applied in combination with the hash functions to obtain the hash values). Based on the k hash values calculated from the k hash functions, the corresponding k positions from among the total of m positions in the bitmap of length m are located, setting the corresponding k bits to 1.

During the data frame reception, as shown in FIG. 5A, the receiver determines that the data frame corresponding to the Sequence Number (SN) 5 has not been successfully received. Therefore, using k hash functions (three hash functions, Hash Functions 1˜3, in this example), the SN=5 is processed, yielding corresponding three results of corresponding hash functions (i.e., three resulting hash values) of 1, 3, and 6. Accordingly, the bits at positions 1, 3, and 6 in the bitmap of length m (length of 8 in this example) are set to 1.

At some point of time later, the receiver determines that the data frame corresponding to the SN=26 has not been successfully received. Similarly, using the bitmap generated in the previous step for SN=5 as a basis, the identification information of the SN=26 is also processed using the same set of the three hash functions, yielding corresponding results of the three hash functions (i.e., three hash values) of 3, 4, and 7. Accordingly, the bits at positions 3, 4, and 7 in the bitmap are also set to 1.

In this example, it is assumed that out of a total of 64 data frames (i.e., 64 MSDUs), two data frames (i.e., SN=5 and SN=26) have not been successfully received. Accordingly, two rounds of mapping operations are performed for the unsuccessfully received data frames, resulting in the final condensed BA bitmap to be fed back (with bits at positions 1, 3, 4, 6, and 7 set to 1). It is understood that this same process is also applicable to the transmission scenario with a total of 1024 unfragmented MSDUs for compressing the overhead of BA feedback.

According to the present disclosure, it is proposed that information on whether data frames for a BA session are lost are represented using a shorter bitmap generated by mapping the identification of only the lost data frames (not all the data frames) to corresponding bits of a condensed BA bitmap with a reduced number of bits, that is, the number of bits for the condensed BA bitmap is much smaller than the number of the data frames (e.g., MPDUs) to be transmitted as a block or a round of data frames in the BA session. In short, during the burst transmission of block of data frames for BA session, the number of correctly transmitted data frames far exceeds the number of unsuccessfully transmitted data frames, so the mechanism of the present disclosure can use a bitmap length m (such as 8-bit length in this example) that is much smaller than the existing BA bitmap mechanism (e.g., 8 octets for 64 unfragmented MSDUs) to provide feedback on the lost data frames. It can also be understood that, the length of m=8 is only an example, and may be set to other values if needed. For example, in case of a total of 1024 data frames (i.e., 1024 unfragmented MSDUs) to be transmitted, the present disclosure can use a different bitmap length m (such as 128-bit length), which is also much smaller than the existing BA bitmap mechanism (e.g., 128 octets for 1024 unfragmented MSDUs) to provide feedback on the lost data frames. This reduces the overhead of BA feedback and saves communication resources, thereby improving transmission efficiency.

It is known that hashing is a technique used to efficiently store and retrieve data in computer systems, which involves mapping data of arbitrary size to a fixed-size value, called a hash code or hash value. This hash value serves as an index into an array or data structure, allowing for quick access to the corresponding data. In the present disclosure, various known hash functions may be used to calculate on the input SN for the lost data frames, and the present disclosure does not limit the construction and quantity of specific hash functions (for example, more or fewer than the three hash functions shown in FIG. 5A is also possible). As an illustrative example, hash functions may be based on modular hashing, multiplicative hashing, cyclic redundancy checks (CRCs), cryptographic hash functions (such as MD5 and SHA-1 and the like), precomputing hash codes and the like.

For instance, the hash function may be in the form of hᵢ(x)=(aᵢ×x+bᵢ) mod M (wherein i=1, 2, or 3 in the example of FIG. 5A for three hash functions, x represents the input value of SN, aᵢ and bᵢ correspond to coefficients of each hash function i, mod means modulo operation, and M means the modulo operation taken with respect to M), it should be noted that more complex computational forms for the hash functions are also possible. As mentioned above, the hash function may also include a modulo operation (the modulo of the length m of the bitmap of the bloom filter) to map the corresponding n input elements to k bit positions within the length m of the bloom filter. It is understood that the disclosure does not limit the specific form of the hash function, as long as the transmitter and receiver agree on the same set of hash functions to enable the mapping of the identification information of lost data frames to the condensed BA bitmap with reduced number of bits and to enable the information restoration.

FIG. 5B shows another exemplary schematic diagram of mapping the identification information of one or more missing data frames of the plurality of data frames to corresponding bits of the condensed BA bitmap according to an embodiment of the present disclosure.

FIG. 5B illustrates an example of using a bloom filter to map the identification information (e.g., Sequence Number together with Fragment Number included in Sequence Control field of a MAC frame format) of lost data frames (e.g., MPDUs) to a condensed BA bitmap with a reduced number of bits, in case of fragmented MSDUs where each MPDU corresponds to one fragment of a corresponding MSDU.

Similar to FIG. 5A, at the initial state of in the schematic diagram 500-B of FIG. 5B, for a bit array of length m (length of 128 in this example), all bits are set to 0.

Next, the process of adding elements representing lost frames to the bloom filter (i.e., mapping the identification information of lost frames to the bitmap) is described.

As shown in FIG. 5B, during the data frame reception, the receiver determines that the data frame corresponding to the Sequence Number SN-3 and Fragment Number FN=4 has not been successfully received (i.e., the MPDU corresponding to Fragment #4 of MSDU #3 has not been successfully received). Therefore, using khash functions (three hash functions, Hash Functions 1˜3, in this example), the input element of SN=3&FN=4 (that is, the entire 16-bit Sequence Control field including Sequence Number and Fragment Number) is processed, yielding corresponding hash function results of 1, 2, and 89. Accordingly, the bits at positions 1, 2, and 89 in the bitmap of length 128 are set to 1.

At a subsequent point of time, the receiver determines that the data frame corresponding to the Sequence Number SN=15 and Fragment Number FN=6 has not been successfully received. Similarly, using the bitmap generated in the previous step as a basis, the input element of SN=15&FN=6 (that is, the entire 16-bit Sequence Control field) is processed using three hash functions, yielding corresponding hash function results of 2, 4, and 7. Accordingly, the bits at positions 2, 4, and 7 in the bitmap are also set to 1.

This mapping process is iteratively repeated for each unreceived data frame, not shown for brevity. As a result, for example, the bits at positions 43 and 127 may also be set to 1 due to the mapping for the later determined lost frames. That is, for a total of 1024 data frames (64 MSDUs, each with 16 fragments), a round of mapping operation is performed for each data frame determined to be lost. After the transmission of a round or a block of 1024 data frames is completed (i.e., after multiple rounds of mapping for each lost frame), the final condensed BA bitmap to be fed back is obtained (with bits at positions 1, 2, 4, 7, 43, 89, and 127 set to 1).

Similar to FIG. 5A, in the present disclosure, the information on whether data frames are lost is represented with a shorter bitmap. Compared to the existing BA feedback mechanism, which requires a larger overhead of 128 octets for a total of 64 MSDUs (each with 16 fragments), the mechanism of the present disclosure can use a much smaller bitmap length m (m<<128 octets, in this example m=128) to provide feedback on the lost data frames, thereby reducing the overhead of BA feedback and saving communication resources.

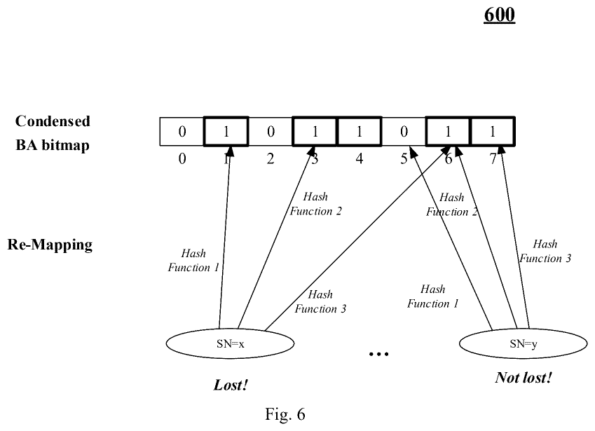

FIG. 6 shows an exemplary schematic diagram of determining missing data frames of the plurality of data frames based on corresponding bits of the condensed BA bitmap according to an embodiment of the present disclosure.

FIG. 6 illustrates the process by which the receiver transmits the condensed BA bitmap through a BA frame, and upon receiving this condensed BA bitmap, the transmitter performs the same mapping process on the identification information of the data frames which have been transmitted during this round or block of data frames. This allows the determination of which frames were lost based on the condensed BA bitmap, enabling retransmission of the lost data frames. The following will provide a detailed description in conjunction with FIG. 6.

As previously described in the process of generating the condensed BA bitmap, the fundamental principle of the bloom filter is to use an array of m bits (i.e., bitmap or bit sequence) as the storage space for the elements of lost frames and k hash functions for computation. Each input element (i.e., each lost frame) is processed through the k hash functions to obtain k hash values (or computational results), setting the corresponding k bit positions in the BA bitmap to 1. Accordingly, upon receiving the BA frame carrying the condensed BA bitmap, the transmitter should determine whether each data frame transmitted in this round exists in the condensed BA bitmap, if the frame exists in the condensed BA bitmap, it means that retransmission for the frame is needed. This is done by calculating the khash values for the element (i.e., the identification information of each data frame) using the same set of k hash functions and then determining whether the elements at the k hash value positions in the bit array are 1. If any bit is not 1 (i.e., if any of these k positions is 0), it may be determined that the element certainly does not exist. If all k positions are 1, the queried element may exist, and retransmission is needed. It should be noted that the existence is possible due to the false positive rate of the bloom filter, which arises from collisions between hash functions.

As shown in the schematic diagram 600 of FIG. 6, after obtaining the condensed BA bitmap (i.e., the BA bitmap generated from FIG. 5A), the process of remapping for each transmitted data frame is carried out again. For example, for a data frame SN=x (x=0˜64 in case of a total of 64 unfragmented MSDUs are transmitted) to be judged, using the same set of three hash functions (i.e., Hash Functions 1 to 3) the three hash values obtained are 1, 3, and 6, and they are re-mapped to positions 1, 3, and 6 in the bitmap. The previously obtained condensed BA bitmap also has positions 1, 3, and 6 set to 1, with a match indicating that data frame SN=x is lost and requires retransmission. Similarly, for a data frame SN=y (y=0˜64 and y #x in case of a total of 64 unfragmented MSDUs are transmitted) to be judged, using the same set of three hash function (i.e., Hash Functions 1 to 3), the three hash values obtained are 5, 6, and 7, and they are re-mapped to positions 5, 6, and 7 in the bitmap. However, the previously obtained condensed BA bitmap has positions 6 and 7 set to 1, but the position 5 of the BA bitmap is 0, thus there is a mismatch in the calculation result for data frame SN=y, indicating that the element for SN=y does not exist in the condensed BA bitmap, and therefore, no retransmission is needed.

It is understood that for each data frame that has been transmitted in this round (i.e., corresponding to FIG. 5A, in the case of a total of 64 unfragmented MSDUs), each of MSDU #0 to 63 should undergo the afore-mentioned remapping process. By comparing the results of the remapping of the bitmaps with the obtained condensed BA bitmap (i.e., determining whether there is a match on a per data frame basis, or equivalently, per-MPDU-basis), it is determined which frames are the lost frames that need to be retransmitted. Similarly, for the BA bitmap generated from FIG. 5B, similar remapping process may be done based on the hash functions on the sequence number together with the fragment number for each fragment of each MSDU to determine whether a retransmission is needed for each fragment, details are omitted herein.

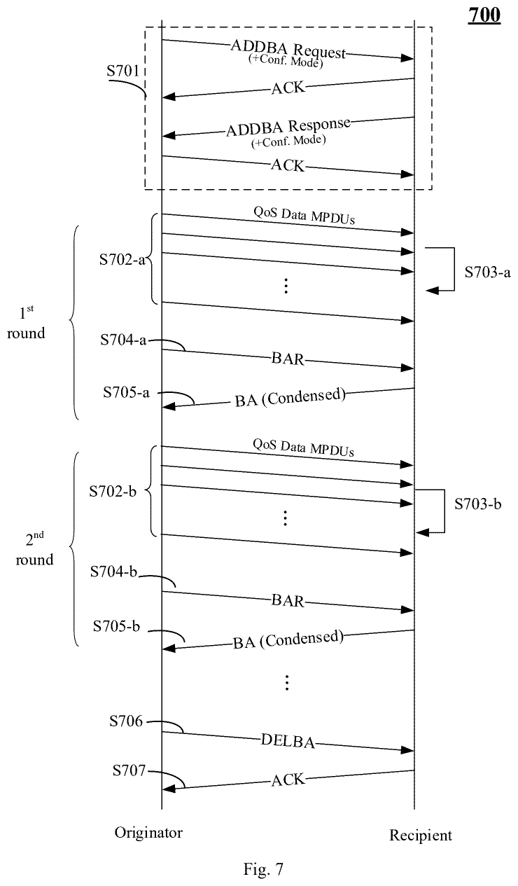

FIG. 7 shows an exemplary schematic diagram illustrating an enhanced immediate BA mechanism according to an embodiment of the present disclosure.

In this embodiment, the overall frame exchange procedure 700 of BA mechanism in FIG. 7 is basically the same as FIG. 2A, and details for the same operations are omitted here. The distinctions lie in the further improvements made to the following processes on the basis of the existing immediate BA mechanism: the interaction phase for the support indication (or specifically, the configuration mode as an implicit support indication) of sparse BA bitmap condensation (S701), the process by which the recipient maps the identification information of each lost data frame to a condensed bitmap with reduced bit positions (S703-a and S703-b), and the process of feedback of the generated condensed bitmap in the BA frame to the originator (S705-a and S705-b). The following will provide a detailed description in conjunction with FIG. 7.

It should be noted that in order for the communicating parties to support sparse BA bitmap condensation, some preparatory operations are needed. For instance, when employing a bloom filter for the sparse BA bitmap condensation, one or more sets of configuration parameters for the bloom filter should be predefined for future use. These configuration parameters should be known between the devices that support sparse BA bitmap condensation.

For example, the one or more different sets of configuration parameters for the bloom filter should be predefined, standardized parameters that are stored in the memory or storage of both the originator and the recipient involved in the communication. These parameters are necessary for both parties to know and have prestored in their storages to support the condensed BA bitmap mechanism, so that they can agree to use any set of configuration parameters for the bloom filter for subsequent communication.

For example, one or more sets of configuration parameters for the bloom filter may be stored within the storage of the wireless driver chip in communication devices, and any one or multiple sets of these configuration parameters may be loaded into the processing unit of the communication device for use. Alternatively, one or more sets of configuration parameters for the bloom filter may be stored within the communication device itself (e.g., a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read-only memory (ROM), a programmable ROM (PROM), an erasable PROM (EPROM), an electrically erasable PROM (EEPROM), a register, a removable disk, and any other suitable medium) for selection and use according to the agreement with the peer communication device. Moreover, these sets of configuration parameters may be updated at any time to add, delete, replace, or modify them, and such updates may be carried out in any manner, as long as both communicating parties store a sufficient number of sets of parameters for selection and use. In a word, the one or more sets of configuration parameters for the bloom filter proposed in the present disclosure are innovative parameters that have never been used or appeared in existing BA mechanisms. Similarly, when other algorithms or mapping rules are used instead of the bloom filter, multiple sets of parameters required for those algorithms can also be pre-stored for arbitrary selection and use from among the multiple sets of parameters.

Thus, once both parties agree on the same set of filter parameters for the bloom filter, the data recipient can use this set of filter parameters stored in its storage or memory or other storing devices of the recipient to perform the mapping process to generate a condensed BA bitmap or bit array, and the data originator can use the same set of filter parameters stored in its storage or memory or other storing devices of the recipient to deduce which data frame is lost and therefore performs retransmission. However, when the communicating parties negotiate which set of parameters to use, there may be no need to exchange the specific values of the parameters; instead, only the serial number or identifier corresponding to the selected set of parameters needs to be exchanged (such as the configuration mode described later).

For example, the configuration parameters for the bloom filter include:
The initialized bit array capacity m (i.e., the length of the bitmap of the bloom filter).
The number of hash functions k.
The expected number of elements to be added n (i.e., the expected number of packet loss in one round or block of data transmission of the BA session).
The false positive rate p may be estimated as: p=(1−e^{-kn/m})^{k}

It is understood that once the parameters m, k, and n are given, the false positive rate p may be derived therefrom. Table 1 provides several examples of configuration parameters.

TABLE 1
Configuration Modes for Bloom Filters

| Conf. | | | | | |
|---|---|---|---|---|---|
| Mode | m | n | k | p | Descriptions |
| 0 | 8 | 0.5 | 6 | 0.0009 | Enhancements on existing compressed |
| | | | | | BA mode with bitmap = 64 bits for |
| | | | | | unfragmented case of 64 MSDUs |
| 1 | 128 | 8 | 6 | 0.0009 | Enhancements on existing |
| | | | | | uncompressed BA mode with bitmap = |
| | | | | | 1024 bits for fragmented case of 64 |
| | | | | | MSDUs each with 16 fragments |
| 2 | 128 | 4 | 6 | 0.0000 | Enhancements on existing compressed |
| | | | | | BA mode with bitmap = 1024 bits for |
| | | | | | unfragmented case of 1024 MSDUs |
| . . . | . . . | . . . | . . . | . . . | . . . |
| . . . | . . . | . . . | . . . | . . . | . . . |
| . . . | . . . | . . . | . . . | . . . | . . . |

It is also understood that the parameters and the number of configuration modes in Table 1 serve only as examples. There may be more or fewer configuration modes, and the parameters m, k, n and p can also differ from the specific values listed in the table. It should be noted that the detailed types or forms or composition of the k hash functions can also be deemed as parameters of each of configuration modes, which may be pre-stored in the storage of the communication devices for future selection and use. In the present disclosure, as long as both parties agree on the same configuration mode (i.e., the same set of configuration parameters) among these multiple configuration modes, for example, based on various factors such as packet loss requirements, computational load of communication devices, false positive rate, and condition for the communication environment, the sparse compression and information restoration may be carried out accordingly, without interaction of the detailed parameter values for the configuration modes.

As shown in FIG. 7, in step S701, a support indication for sparse BA bitmap condensation (e.g., support or not support) may be included in the ADDBA request/response frame, and after S701 is completed, the originator and recipient can agree on that the sparse BA bitmap condensation is to be used for future processing (e.g., generation and parsing) of the condensed BA bitmap, which may reduce the BA overhead. In case that there may be multiple configurations modes to be used for different transmission scenarios (such as, a total number of 64 unfragmented MSDU, a total number of 1024 unfragmented MSDU, a total number of 64 fragmented MSDU each having 16 fragments), it is preferable that a configuration mode information (e.g., configuration mode number #0, #1, . . . , or another sequence number) can also be included in the ADDBA request/response frame as an addition or replacement to the support indication (e.g., as implicit indication of support or not support), and after S701 is completed, the originator and recipient can agree on the corresponding bloom filtering-related parameters to be adopted subsequently, which will be particular useful for this transmission scenario.

Thereafter, there will be several rounds of data transmission, as indicated by the 1^{st} round and the 2^{nd} round of the sequence 700 of FIG. 7.

Next, in step S702-a, the originator can transmit a series of data frames (e.g., QoS Data MPDUs), and in step S703-a, the recipient can map the identification information of lost data frames (lost MPDUs), such as sequence numbers or a combination of sequence numbers and fragment numbers, to a BA bitmap or bloom filter bit array with reduced bit positions using hash functions of the bloom filter, as described in conjunction with FIG. 5A and FIG. 5B.

Subsequently, in step S704-a, the originator sends a BAR, and correspondingly, in step S705-a, the recipient sends, as a response to the BAR, a BA frame carrying the condensed BA bitmap or the bloom filter bit array generated in step S703-a.

Thereafter, the originator can receive the condensed BA bitmap and remap the identification information of each data frame which has been transmitted in step S702-a using the same set of bloom filter parameters to determine which frames are lost (as described in conjunction with FIG. 6) and should be retransmitted in the next round of transmission (not shown), e.g., retransmitted during the second round of transmission in S702-b.

Subsequently, the next round of data frame transmission and BA feedback may be carried out, with steps S702-b through S705-b being essentially similar to the previously described steps S702-a through S705-a, and thus not repeated. Similarly, multiple rounds of data frame transmission and BA feedback may be conducted in a same way. Thereafter, the BA session may be torn down through the DELBA and ACK interactions in steps S706 and S707.

It is understood that although FIG. 7 depicts the indication of the configuration mode in the ADDBA request/response frame, the support indication for sparse BA bitmap condensation (and additionally, the configuration mode information) can also be carried at other stages of the BA session, in other existing frames, or in newly defined separate frames (e.g., a sparse BA bitmap condensation support indication frame or a bloom filter configuration mode notification frame, and the like). The present disclosure does not limit the timing or the specific frame carrying the sparse BA bitmap condensation support and/or the configuration mode indication. For instance, during the data transmission process, it may be discovered that other filter parameters are more suitable, and the updated configuration mode indication may be carried at subsequent appropriate time points or frame structures for dynamic adjustment.

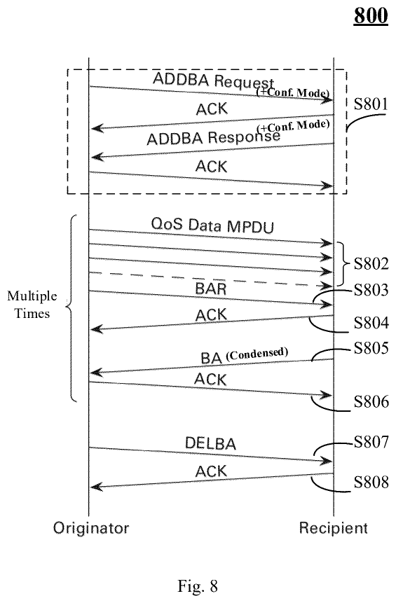

FIG. 8 shows an exemplary schematic diagram illustrating an enhanced immediate BA mechanism according to an embodiment of the present disclosure.

It should be noted that, the overall data frame exchange procedure 800 of Delayed BA mechanism of FIG. 8 is basically the same as the Immediate BA mechanism of FIG. 2A, both including a setup stage (including step S801 of FIG. 8), a data transfer stage (including steps S802-S806 of FIG. 8), and a tear down stage (including steps S807-S808 of FIG. 8). Immediate BA of FIG. 2A and delayed BA of FIG. 8 differ in the handling of the BAR and BA frames during the data transfer phase. With immediate BA, the BAR solicits an immediate BA response, while with delayed BA, correct reception of the BAR frame itself (in step S803) is acknowledged with an ACK (in step S804) and the BA is returned in a separate channel access (in step S805) and acknowledged with another ACK (in step S806), details for the same operations of the frame interactions are omitted here.

It should be noted that the sparse BA bitmap condensation mechanism proposed in the present disclosure can also be applied to the Delayed BA mechanism, with improvements similar to those depicted in FIG. 7. The main aspects of these improvements include: the interaction phase for the support indication (and additionally or alternatively, the configuration mode) of sparse BA bitmap condensation (S801), the process by which the recipient maps the identification information of each lost data frame to a condensed bitmap with reduced bit positions (not shown), and the process of feedback of the generated condensed bitmap in the BA frame to the originator (S805). Details of the improvements are omitted here.

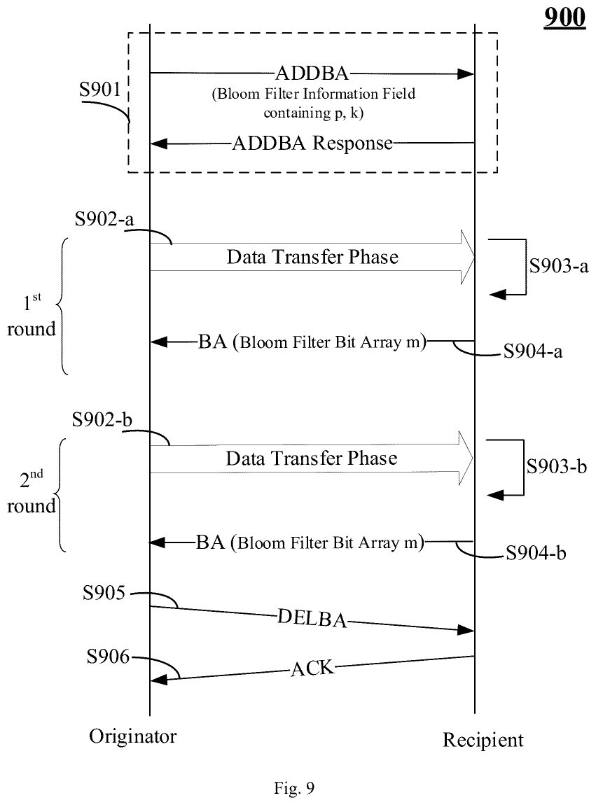

FIG. 9 shows another exemplary schematic diagram illustrating an enhanced BA mechanism according to an embodiment of the present disclosure.

It should be noted that, the overall data frame exchange procedure 900 of enhanced BA mechanism of FIG. 9 is basically the same as the BA mechanisms of FIG. 7 and FIG. 8, but the procedure 900 of FIG. 9 does not distinguish between delayed BA and immediate BA. The difference for the overall data frame exchange procedure 900 lies in that, the parameters of the bloom filter are signaled in a different manner than those of FIG. 7 and FIG. 8.

To be specific, as mentioned above, bloom filtering is a space-efficient data structure to record whether an element is a member of a set, if only a small portion of elements are the members in the set. In 802.11 standard, bloom filtering is utilized to represent of a set of services leveraging Service Hint element in Pre-association discovery (PAD) functionality, as described in Section 11.23 of IEEE 802.11-2020 standard. For example, hash values of services are mapped into respective bit positions of the Bloom Filter Bit Array field, which can reduce the number of bits to represent these services. In view of this, the inventors recognize that bloom filter is a suitable representation of a set of lost MPDUs when transmitting a block of MPDUs in the Block Ack procedure, for the following reasons. First, due to the sparsity of current Block Ack bitmap, a significant size reduction of bitmap may be achieved with a relatively low false positive probability. Second, due to the characteristic of bloom filtering, only false positive probability exists, so all lost MPDUs may be feedback via bloom filter-based Block Ack representation. In this case, the present disclosure proposes to indicate the lost MPDUs based on bloom filter operation (which has been described above) by encoding the current BA bitmap field into Bloom Filter Bit Array field of a BA frame, and to indicate at least some of the parameters of the bloom filter using a Bloom Filter Information field.

As mentioned above, for bloom filtering, there are 4 parameters (p, m, k, n), and any three of them are chosen, the remaining one may be determined accordingly, based on p=(1−e^{-kn/m})^{k}, wherein p represents False Positive Probability, k represents Number of Hash Functions, n represents Number of Lost MPDUs, m represents Size of Bloom Filter Bit Array.

In the present disclosure, it is proposed that the Bloom Filter Information field of may be used in BA procedure, for example, added to ADDBA request frame as a new field, which may be used to indicate the stochastic characteristics of the bloom filter. For example, similar to that is used in PAD procedure, the format of the Bloom Filter Information field may include “False Positive Probability Range” subfield and “Number Of Hash Functions” subfield, wherein the former represents the false positive probability range of the bloom filter with each value of this subfield indicating a corresponding false positive probability range, as described in Table 9-320 of IEEE 802.11-2020 standard, and the latter represents the number of hash functions used by the bloom filter. Accordingly, the value of False Positive Probability Range subfield may be used to determine the parameter p, and the value of Number of Hash Functions subfield may be used to determine the parameter k, and the parameters of p and k may be exchanged between the communication devices involved in BA session.

In addition, regarding the parameter n and m, since the lost MPDUs is known to the receipt, so the receipt knows the number of lost MPDUs, and thus can determine the size of bloom filter bit array m, based on the above relationship p=(1−e^{-kn/m})^{k}. Accordingly, the parameters of the bloom filter to use may be determined, and the determined bloom filter is used to map the identification information of the lost frames as mentioned above, which results in a condensed bitmap or equivalently, bloom filter bit array. Next, the receipt may organize it in octets e.g., by the operation of [m/8], and transmit the resulting bloom filter bit array in a BA frame to the originator to allow for the retransmission of the lost frames.

It should be noted that the two parameters p and k indicated by the Bloom Filter Information field of the ADDBA request frame, the detailed fields/subfields to indicate the parameters, as well as the way of how to determine the parameter n are provided only as examples, the present disclosure does not restrict the way of signaling or determining the parameters, as long as at least part (e.g., any subset of parameters of p, k, n and m) or all of the parameters for the bloom filter may be indicated via information exchange and remaining parameters (if any) may be derived, such that the same set of bloom filter parameters will be used for subsequent BA session.

As shown in FIG. 9, in step S901, ADDBA request frame may be transmitted from the originator to the recipient, wherein the ADDBA request frame may include a Bloom Filter Information field, which may further include “False Positive Probability Range” subfield and “Number Of Hash Functions” subfield, as mentioned above. It may be understood that Bloom Filter Information field included in the ADDBA request frame is an implicit indication of support indication for sparse BA bitmap condensation by the originator. Afterwards, ADDBA response may be transmitted from the recipient to the originator to complete the BA setup.

Thereafter, there will be several rounds of data transmission, as indicated by the 1^{st} round and the 2^{nd} round of the sequence 900 of FIG. 9.

Next, in step S902-a, the originator can transmit a series of data frames (e.g., QOS Data MPDUs, which may be the case of a block of MPDUs separated by SIFS or A-MPDU within a PPDU), and in step S903-a, the recipient can determine the size of bloom filter bit array m, based on n, k, p, as mentioned above, and then map the identification information of lost data frames (lost MPDUs), such as sequence numbers or a combination of sequence numbers and fragment numbers, to the bloom filter bit array with reduced bit positions using hash functions of the bloom filter.

Subsequently, in step S904-a, the recipient sends a BA frame carrying the condensed BA bitmap or the bloom filter bit array generated in step S703-a. It should be noted that since the SNs of lost MPDUs are mapped into Bloom Filter Bit Array, the resulting Bloom Filter Bit Array, instead of the conventional sparse bitmap field, is used in BA frame.

Thereafter, the originator can receive the condensed BA bitmap (i.e., the bloom filter bit array) and decode the Bloom Filter Bit Array field to determine the lost MPDUs, e.g., by remapping the identification information of each data frame which has been transmitted in step S902-a using the same set of bloom filter parameters to determine which frames are lost and should be retransmitted in the next round of transmission (not shown), e.g., retransmitted during the second round of transmission in S902-b.

Subsequently, the next round of data frame transmission and BA feedback may be carried out, with steps S902-b through S904-b being essentially similar to the previously described steps S902-a through S904-a, and thus not repeated. Similarly, multiple rounds of data frame transmission and BA feedback may be conducted in a same way. Thereafter, the BA session may be torn down through the DELBA and ACK interactions in steps S905 and S906.

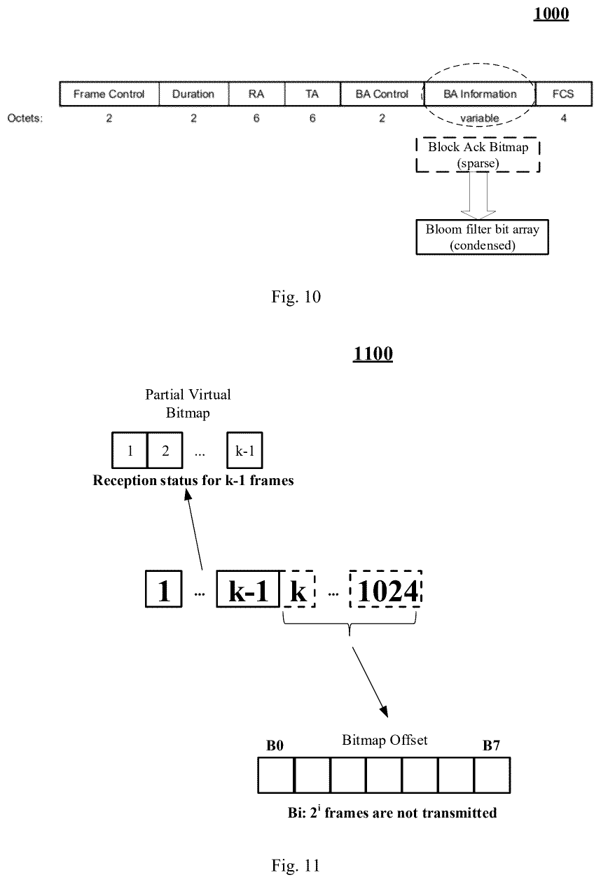

FIG. 10 shows an exemplary schematic diagram illustrating a frame structure for the enhanced BA mechanism according to an embodiment of the present disclosure.

As may be seen in FIG. 10, the BlockAck frame format is illustrated, which for example, includes BA control field and BA Information field, and the meaning of this BA Information field depends on the BlockAck frame variant type. However, regardless of which variant is used, the BA Information field includes a Block Ack bitmap, which is sparse array and needs to be condensed according to the present disclosure. As mentioned above, in the present disclosure, a bloom filter bit array filed is used to replace Block Ack bitmap, which applies for each BlockAck frame variant type.

In addition, although not shown, 1 bit in the reserved subfield of BA information field for the BA frame may be used to indicate that the bloom filter bit array field rather than block ack bitmap is used.

Although the above description introduces the sparse BA bitmap condensation with reference to the Immediate and Delayed BA mechanisms, those skilled in the art would appreciate that the sparse BA bitmap condensation approach may be applied to various existing BA mechanisms including but not limited to the immediate BA mechanism, the delayed BA mechanism, the HT-immediate BA mechanism, and the HT-delayed BA mechanism and the like, the present disclosure does not limit the detailed BA mechanism to be enhanced.

Also, as for exemplary ways for the calculations for the Bloom Filter Bit Array, it may refer to the related operations described in Section 11.23.5 in IEEE Std 802.11-2020.

Accordingly, the acknowledgement procedure may be enhanced, e.g., to meet low latency targets in HUR. In comparison to the conventional bitmap utilized in current Block Ack frame, Bloom Filter Bit Array field can condense the bitmap size, hence reduce the air-time consumption of bitmap in Block Ack frame, leading to low latency improvement.

On the other hand, as mentioned above in combination with FIG. 3, the number of required QoS MPDUs is commonly smaller than array size of bitmap (64bits or 1024bits), hence the bit array of bitmap is not fully utilized to indicate the QoS frames are received or not. In case of large PPDU being split into small PPDUs, the inefficient usage of bitmap is significantly severer in preemption scenarios. Also, even without the operation of splitting large PPDU into smaller PPDUs, it is common that the transferred number of QoS MPDUs is smaller than array size of block ack bitmap, and a great number of bits in the block ack bitmap carry no information about the reception status of MPDUs, which is unnecessary overhead.

In this case, inventors recognize that the sparsity of bitmap field of the existing BA frame has the potential to condense, and proposes using a partial virtual bitmap field design in BA frame to replace the current bitmap subfield of BA frame, such that it may indicate the reception status of MPDUs which are actually transmitted in a PPDU, and reduce overhead.

For example, in case of current BA bitmap design of a length of 1024, the maximum number of data frames that may be transmitted (e.g., the buffer size at the recipient) in the BA session is 1024. If one bit of the BA bitmap is utilized to indicate the reception status for each data frame in the BA session in case of the maximum number of transmitted data frames, a 1024-bit bitmap of current BA bitmap design is needed. However, in many cases, only a small portion of the maximum number of data frames are actually transmitted in the BA session, so the bit positions corresponding to the frames not transmitted carry no information on the reception status and useless. As an example, there may be only 50 data frames transmitted, and the first 50 bit positions of the current BA bitmap may indicate whether each of the 50 data frames is successfully received or not, and the remaining bit positions (e.g., 50 to 1024) do not provide useful information. Thus, the bitmap with a size of 1024 bits is sparse in many cases.

In view of the above, the present disclosure proposes reducing the size of 1024 bits of bitmap leveraging the sparsity by considering the number of actually transmitted data frames. For example, a partial virtual bitmap may be used to indicate the reception of each of the actually transmitted data frames (such as MPDUs/A-MPDU frames in one BA session), and a bitmap offset (also referred to as bitmap control) may be used to indicate the start position of the frames not transmitted or equivalently the end position of the actually transmitted data frames, to account for the case where the transferred number of QoS MPDUs is smaller than array size of block ack bitmap and thus the bit array of BA bitmap is not fully utilized. In this way, the size of BA bitmap may be condensed. For example, also in the case where there may be only 50 data frames transmitted, the first 50 bit positions of the condensed BA bitmap may indicate whether each of the 50 data frames is successfully received or not, and several remaining bit positions (such as 1 octet) may be used to indicate the start position of the frames not transmitted or equivalently the end position of the actually transmitted data, which has a significantly reduced size of bitmap compared with the traditional size of 1024 bits.

FIG. 11 shows an exemplary schematic diagram of condensing the BA bitmap based on a partial virtual bitmap mechanism according to an embodiment of the present disclosure.

As shown in FIG. 11, the present disclosure encodes current BA bitmap field into the BA feedback with reduced size and thus reduced overhead, which may include a partial virtual bitmap for each transmitted data frame (e.g., actually transmitted MPDUs/A-MPDU frames) of the plurality of data frames and indication of the span (or bitmap offset) of the partial virtual bitmap, e.g., starting and ending bit positions of corresponding BA bitmap in existing BA mechanism. In the present disclosure, it is assumed that the head of the current Block Ack bitmap will be used first, and then the tail of the current Block Ack bitmap will be filled with 0s if there are not so many data frames transmitted in the BA session. Accordingly, the span or the bitmap offset of the partial virtual bitmap may be determined based on a number of data frames (e.g., untransmitted MPDUs/A-MPDU frames) not transmitted in the BA session.

For example, in combination with FIG. 11, in the existing BA mechanism, regardless of the number of actually transmitted data frames in a BA session, a BA bitmap with a length of 1024 should be carried in the BA frame, but the k˜1024 bits of the BA bitmap do not carry useful information. In contrast, the present disclosure considers the number of actually transmitted data frames (or equivalently, the number of data frames not transmitted), and uses the bitmap offset to record the number of untransmitted frames, while generating a partial bitmap for the actually transmitted frames. Since the overhead for the actually transmitted frames unchanged, the overhead reduction may be reflected at bit positions k˜1024, which means the bits can reduce from 1024-k to 8.

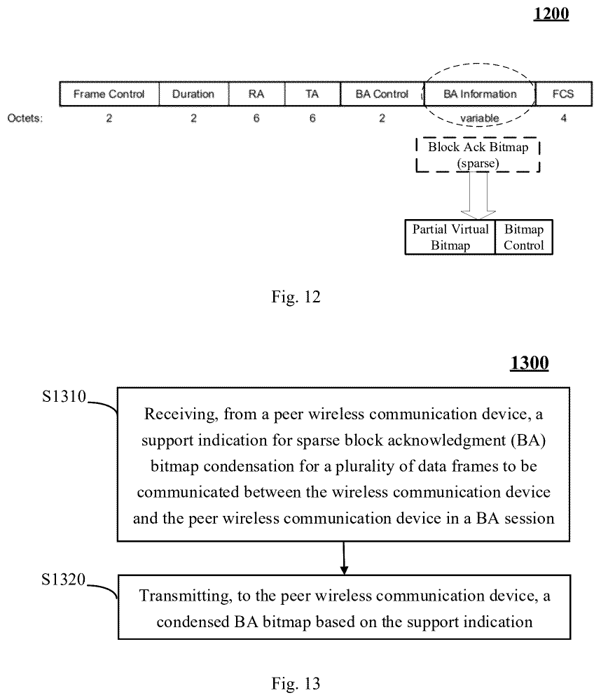

FIG. 12 shows an exemplary schematic diagram illustrating another frame structure for the enhanced BA mechanism according to an embodiment of the present disclosure.

As may be seen in FIG. 12, and with reference to FIG. 10, the BlockAck frame format may include BA control field and BA Information field, and the meaning of this BA Information field depends on the BlockAck frame variant type. However, regardless of which variant is used, the BA Information field includes a Block Ack bitmap, which is sparse array and needs to be condensed according to the present disclosure. As mentioned above, in the present disclosure, a partial virtual bitmap field together with a bitmap control field (i.e., corresponding to the above described bitmap offset) may be used to replace Block Ack bitmap, which applies for each BlockAck frame variant type.

In other words, for current Block Ack bitmap with 128 octets, it can represent the reception status for a maximum number of 1024 MPDUs. Hence, there are at most 1023 zeros in the tail of current Block Ack bitmap. According to the present disclosure, it is sufficient to use one octet of bitmap offset (also referred to as Bitmap Control field described above) to indicate the number of zeros at the tail of current Block Ack bitmap, where each bit at i^{th} offset in Bitmap Control field represents 2ⁱ zeros. The remaining MPDUs in the head of current Block Ack bitmap may be calculated as N=(2\hat{ }(octets in Block Ack bitmap)−the number of zeros represented in Bitmap Control field). Here, for the Partial Virtual bitmap field, the operation of [N/8] octets may be used to represent the receipt status of actually transmitted MPDUs, wherein if bit number k (0≤k≤N) in the Partial Virtual bitmap is 1, it indicates the i^{th} MPDU is received successfully.

In comparison to the conventional bitmap field utilized in current Block Ack frame, partial virtual bitmap field together with the bitmap offset of the present disclosure can condense the bitmap size, hence reduce the transmission consumption of bitmap in BA frame.

In addition, the partial virtual bitmap has a variable length, such that the frame structure for the enhanced BA mechanism proposed in the present disclosure applies for each BlockAck frame variant type with different sizes of block ack bitmap and may be adaptive to various requirements in wireless communication.

In addition, although not shown, 1 bit in the reserved subfield of BA information field for the BA frame may be used to indicate that the proposed bitmap variant using Bitmap Control and Partial Virtual bitmap field is used.

FIG. 13 shows a flowchart of a computer-implemented method of wireless communication according to an embodiment of the present disclosure.

The method may be implemented in the wireless communication device (namely, the recipient as mentioned above) and the detailed description of method 1300 can refer to the content described in the above with respect to FIGS. 1-12. For example, method 1300 may be executed in the architecture described with respect to FIGS. 1-12 and according to the interactions between the originator and recipient when transmitting data frames therebetween using the enhanced BA mechanism as described with respect to FIGS. 1-12. In addition, each step of method 1300 may be performed by one or more processing units, such as central processing unit (CPU) of the client device.

With reference to FIG. 13, method 1300 comprises steps S1310-S1320.

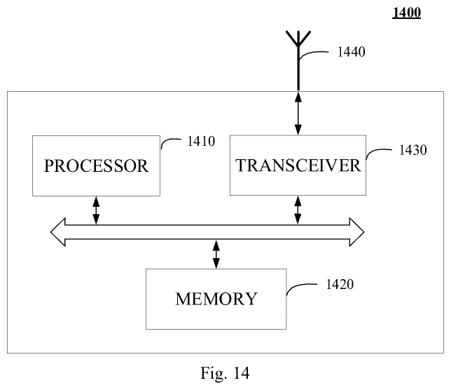

At step S1310, the wireless communication device (e.g., the recipient) may receive, e.g., by using a receiver of a transceiver the wireless communication device as described in FIG. 14, from a peer wireless communication device (e.g., the originator), a support indication for sparse BA bitmap condensation for a plurality of data frames to be communicated between the wireless communication device and the peer wireless communication device in a BA session.

At step S1320, the wireless communication device may transmit, e.g., by using a transmitter of the transceiver of the wireless communication device as described in FIG. 14, to the peer wireless communication device, a condensed BA bitmap for the BA session based on the support indication.

According to an embodiment, the condensed BA bitmap may be generated by mapping identification information of one or more missing data frames of the plurality of data frames to corresponding bits of the condensed BA bitmap.

According to an embodiment, the support indication for sparse BA bitmap condensation indicates a support of algorithmic mapping of the one or more missing data frames to the corresponding bits of the condensed BA bitmap with a second number of bits less than a first number of the plurality of data frames, instead of a one-to-one mapping between data frames and bits of a BA bitmap.

According to an embodiment, mapping the identification information of the one or more missing data frames to the corresponding bits of the condensed BA bitmap comprises: mapping the identification information of the one or more missing data frames to the corresponding bits of the condensed BA bitmap using a bloom filter. In addition, the bloom filter comprises a bloom filter bit array as the condensed BA bitmap.

According to an embodiment, locations of the corresponding bits in the condensed BA bitmap are determined based on results of a set of hash functions of the bloom filter on the identification information of the one or more missing data frames.

According to an embodiment, the support indication is configured to indicate a configuration mode of the sparse BA bitmap condensation among a plurality of different configuration modes. In addition, the configuration mode corresponds to one or more parameters of the bloom filter.

According to an embodiment, the one or more parameters of the bloom filter corresponding to the indicated configuration mode are determined by the wireless communication device and the peer wireless communication device for use in the BA session based on the one or more parameters of the bloom filter for the plurality of different configuration modes stored in both the wireless communication device and the peer wireless communication device.

According to an embodiment, the bloom filter is configured with one or more parameters of: a length of the bloom filter bit array; a number of hash functions; a number of entries to be mapped to the bloom filter bit array; and a false positive rate of the bloom filter. According to the embodiment, the one or more parameters of the bloom filter may not only include the number of hash functions but also the specific form or composition of each of the hash functions for each of the configuration modes.

According to an embodiment, the support indication is included in an ADDBA request frame indicating a request for establishing the BA session.

According to an embodiment, one or more parameters of the bloom filter is indicated in an ADDBA request frame from the peer wireless communication device and indicating a request for establishing the BA session, and the bloom filter bit array is included in a BA frame to be transmitted to the peer wireless communication device.

According to an embodiment, the plurality of data frames correspond to a plurality of MAC Protocol Data Units (MPDUs).

According to a first example of the embodiment, each of the plurality of MPDUs corresponds to one of a plurality of MAC Service Data Units (MSDUs). Accordingly, mapping the identification information of the one or more missing data frames to the corresponding bits of the condensed BA bitmap comprises: mapping a sequence number of each of the one or more missing data frames to the corresponding bits of the condensed BA bitmap.

According to a second example of the embodiment, each of the plurality of MPDUs corresponds to one fragment of a corresponding MAC Service Data Unit (MSDU) among a plurality of MSDUs. Accordingly, mapping the identification information of the one or more missing data frames to the corresponding bits of the condensed BA bitmap comprises: mapping a sequence number and a fragment number of each of the one or more missing data frames to the corresponding bits of the condensed BA bitmap.

According to an embodiment, the wireless communication device may receive, from the peer wireless communication device, a retransmission of the one or more missing data frames of the plurality of data frames.

Accordingly, the one or more missing data frames are determined by the peer wireless communication device by: mapping, for each of the plurality of data frames, the identification information of the data frame to corresponding positions of the condensed BA bitmap; and determining the data frame as a missing data frame in response to a match of the corresponding positions with the corresponding bits of the condensed BA bitmap.

According to an embodiment, the condensed BA bitmap is generated by generating a partial virtual bitmap for each transmitted data frame of the plurality of data frames and a bitmap offset for the partial virtual bitmap.

According to an embodiment, the bitmap offset is generated based on an indication of a number of data frames not transmitted in the BA session.

According to an embodiment, the partial virtual bitmap has a variable length, and the bitmap offset has a length of 1 octet.

At least based on the above embodiments of the present disclosure, the enhancement provides efficient solutions for reducing the overhead associated with the BA frames or bitmaps.

FIG. 14 is an exemplary block diagram illustrating a computing device according to embodiments of the disclosure.

It should be noted that the computing device depicted in FIG. 14 can correspond to one or more of the originator, the recipient, the wireless communication device and the peer wireless communication device as described in FIGS. 1-13 and may be used to perform the actions involved in the BA mechanism, for example, the method 1300 as described above.

As shown in FIG. 14, the computing device 1400 can comprise processor 1410, memory 1420, transceiver 1430 and at least one antenna 1440. The processor 1410 is communicatively coupled with the memory and the transceiver and configured to perform the methods discussed above, e.g., to transmit frames to and receive frames from other computing devices by using the transceiver and the antenna under the control of the computer program instructions stored in the memory and loaded to the processor. According to embodiments of the present disclosure, the processor (such as a baseband processor) is configured to cause one or more operations of the methods discussed above to occur, e.g., to cause an apparatus (e.g., the wireless communication device or the peer wireless communication device as described above in FIGS. 1-13) to perform operations or a method of the above-mentioned BA procedure.

Examples of the processor 1410 comprise microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The processor 1410 can execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on memory 1420.

The memory 1420 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read-only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The memory 1420 may reside in the processor 1410, external to the processor 1410, or distributed across multiple entities including the processor 1410. The memory 1420 may be embodied in a computer program product. By way of example, a computer program product may include a computer-readable medium in packaging materials. Those skilled in the art will recognize how to implement the described functionality presented throughout this disclosure depending on the particular application and the overall design constraints imposed on the overall system.

The transceiver 1430 may be a radio frequency (RF) transceiver and include an RF transmitter and an RF receiver (not shown). For example, the transceiver 1430 can comprise separate transmitter and receiver or a single transceiver in which the transmitter and the receiver are integrated. The transmitter can transmit RF signals via at least one antenna 1440 to one or more other computing devices, and can also receive RF signals via at least one antenna 1440 from one or more other computing devices, to allow for communications with other devices.

In addition, according to another embodiment of the present disclosure, a computer program product for wireless communication is disclosed. As an example, the computer program product comprises a non-transitory computer readable storage medium having program instructions embodied therewith, and the program instructions are executable by a processor. When executed, the program instructions cause the processor to perform one or more of the above described procedures, and details are omitted herein for conciseness.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

Expression such as “according to”, “based on”, “dependent on”, and so on as used in the disclosure does not mean “according only to”, “based only on”, or “dependent only on”, unless it is explicitly otherwise stated. In other words, such expression generally means “according at least to”, “based at least on”, or “dependent at least on” in the disclosure.

Any reference in the disclosure to an element using the designation “first”, “second” and so forth is not intended to comprehensively limit the number or order of such elements. These expressions may be used in the disclosure as a convenient method for distinguishing two or more units. Thus, a reference to a first unit and a second unit does not imply that only two units may be employed or that the first unit must precede the second unit in some form.

The term “determining” used in the disclosure can include various operations. For example, regarding “determining”, calculating, computing, processing, deriving, investigating, looking up (e.g., looking up in tables, databases, or other data structure), ascertaining, and so forth are regarded as “determination”. In addition, regarding “determining”, receiving (for example, receiving information), transmitting (for example, transmitting information), input, output, accessing (for example, access to data in the memory), and so forth, are also regarded as “determining”. In addition, regarding “determining”, resolving, selecting, choosing, establishing, comparing, and so forth can also be regarded as “determining”. That is, regarding “determining”, several actions may be regarded as “determining”.

The terms such as “connected”, “coupled” or any of their variants used in the disclosure refer to any connection or combination, direct or indirect, between two or more units, which can include the following situations: between two units that are “connected” or “coupled” with each other, there are one or more intermediate units. The coupling or connection between the units may be physical or logical, or can also be a combination of the two. As used in the disclosure, two units may be considered to be electrically connected through the use of one or more wires, cables, and/or printed, and as a number of non-limiting and non-exhaustive examples, and are “connected” or “coupled” with each other through the use of electromagnetic energy with wavelengths in a radio frequency region, the microwave region, and/or in the light (both visible and invisible) region, and so forth.

When used in the disclosure or the claims ‘including”, “comprising”, and variations thereof, these terms are as open-ended as the term “having”. Further, the term “or” used in the disclosure or in the claims is not an exclusive-or.

The present disclosure has been described in detail above, but it is obvious to those skilled in the art that the present disclosure is not limited to the embodiments described in the disclosure. The present disclosure may be implemented as a modified and changed form without departing from the spirit and scope of the present disclosure defined by the description of the claims. Therefore, the description in the disclosure is for illustration and does not have any limiting meaning to the present disclosure.

What is claimed is:

1. A method for wireless communication implemented in a wireless communication device and comprising:
receiving, from a peer wireless communication device, a support indication for sparse block acknowledgment (BA) bitmap condensation for a plurality of data frames to be communicated between the wireless communication device and the peer wireless communication device in a BA session; and
transmitting, to the peer wireless communication device, a condensed BA bitmap for the BA session based on the support indication.

2. The method of claim 1, wherein the condensed BA bitmap is generated by mapping identification information of one or more missing data frames of the plurality of data frames to corresponding bits of the condensed BA bitmap.

3. The method of claim 2, wherein:
the support indication for sparse BA bitmap condensation indicates a support of algorithmic mapping of the one or more missing data frames to the corresponding bits of the condensed BA bitmap with a second number of bits less than a first number of the plurality of data frames, instead of a one-to-one mapping between data frames and bits of a BA bitmap.

4. The method of claim 2, wherein mapping the identification information of the one or more missing data frames to the corresponding bits of the condensed BA bitmap comprises:
mapping the identification information of the one or more missing data frames to the corresponding bits of the condensed BA bitmap using a bloom filter, and wherein:
the bloom filter comprises a bloom filter bit array as the condensed BA bitmap.

5. The method of claim 4, wherein locations of the corresponding bits in the condensed BA bitmap are determined based on results of a set of hash functions of the bloom filter on the identification information of the one or more missing data frames.

6. The method of claim 4, wherein:
the support indication is configured to indicate a configuration mode of the sparse BA bitmap condensation among a plurality of different configuration modes, wherein:
the configuration mode corresponds to one or more parameters of the bloom filter.

7. The method of claim 6, wherein:
the one or more parameters of the bloom filter corresponding to the indicated configuration mode are determined by the wireless communication device and the peer wireless communication device for use in the BA session based on the one or more parameters of the bloom filter for the plurality of different configuration modes stored in both the wireless communication device and the peer wireless communication device.

8. The method of claim 4, wherein the bloom filter is configured with one or more parameters of:
a length of the bloom filter bit array;
a number of hash functions;
a number of entries to be mapped to the bloom filter bit array; and
a false positive rate of the bloom filter.

9. The method of claim 2, wherein the support indication is included in an ADDBA request frame indicating a request for establishing the BA session.

10. The method of claim 4, wherein
one or more parameters of the bloom filter is indicated in an ADDBA request frame from the peer wireless communication device and indicating a request for establishing the BA session, and the bloom filter bit array is included in a BA frame to be transmitted to the peer wireless communication device.

11. The method of claim 2, wherein the plurality of data frames correspond to a plurality of MAC Protocol Data Units (MPDUs).

12. The method of claim 11, wherein each of the plurality of MPDUs corresponds to one of a plurality of MAC Service Data Units (MSDUs), and wherein:
mapping the identification information of the one or more missing data frames to the corresponding bits of the condensed BA bitmap comprises:
mapping a sequence number of each of the one or more missing data frames to the corresponding bits of the condensed BA bitmap.

13. The method of claim 11, wherein each of the plurality of MPDUs corresponds to one fragment of a corresponding MAC Service Data Unit (MSDU) among a plurality of MSDUs, and wherein:
mapping the identification information of the one or more missing data frames to the corresponding bits of the condensed BA bitmap comprises:
mapping a sequence number and a fragment number of each of the one or more missing data frames to the corresponding bits of the condensed BA bitmap.

14. The method of claim 2, further comprising:
receiving, from the peer wireless communication device, a retransmission of the one or more missing data frames of the plurality of data frames, wherein the one or more missing data frames are determined by the peer wireless communication device by:
remapping, for each of the plurality of data frames, the identification information of the data frame to corresponding positions of the condensed BA bitmap; and
determining the data frame as a missing data frame in response to a match of the corresponding positions with the corresponding bits of the condensed BA bitmap.

15. The method of claim 1, wherein the condensed BA bitmap is generated by generating a partial virtual bitmap for each transmitted data frame of the plurality of data frames and a bitmap offset for the partial virtual bitmap.

16. The method of claim 15, wherein the bitmap offset is generated based on an indication of a number of data frames not transmitted in the BA session.

17. The method of claim 15, wherein the partial virtual bitmap has a variable length, and the bitmap offset has a length of 1 octet.

18. The method of claim 1, wherein:
the wireless communication device is an Access Point (AP) and the peer wireless communication device is a non-AP station; or the wireless communication device is a non-AP station and the peer wireless communication device is an AP.

19. A wireless communication device comprising:
one or more processors;
a memory coupled to at least one of the processors; and
a set of computer program instructions stored in the memory, which, when executed by at least one of the processors, perform actions of:
receiving, from a peer wireless communication device, a support indication for sparse block acknowledgment (BA) bitmap condensation for a plurality of data frames to be communicated between the wireless communication device and the peer wireless communication device in a BA session; and
transmitting, to the peer wireless communication device, a condensed BA bitmap for the BA session based on the support indication.

20. A computer program product for wireless communication, the computer program product comprising a non-transitory computer readable storage medium having program instructions embodied therewith, the program instructions executable by a processor of a wireless communication device to cause the processor to:
receive, from a peer wireless communication device, a support indication for sparse block acknowledgment (BA) bitmap condensation for a plurality of data frames to be communicated between the wireless communication device and the peer wireless communication device in a BA session; and
transmit, to the peer wireless communication device, a condensed BA bitmap for the BA session based on the support indication.
